(19) United States
(12) Patent Application Publication
(10) Pub. No.: US 2006/0294108 A1
(43) Pub. Date: Dec. 28, 2006

(54) System for and method of managing schedule compliance and bidirectionally communicating in real time between a user and a manager

(76) Inventors: Alex M. Adelson, Andes, NY (US); Steven Verhoest, Gentbrugge (BE); Sanjeev Gupta, Gent (BE); John Heffer, Chappaqua, NY (US)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/403,792

(22) Filed: Apr. 13, 2006

Related U.S. Application Data
(60) Provisional application No. 60/671,283, filed on Apr. 14, 2005.

(51) Int. Cl. G06F 17/30

(52) U.S. Cl. 707/10

(57) ABSTRACT

A compliance/adherence management and automated data collection system uses a plurality of communications modalities implemented over wireless or wired communications systems for redundantly and persistently transmitting messages to and/or receiving messages from an end user for managing compliance/adherence of the end user concerning schedules and medication and treatment protocols. The system also uses wireless or wired communications modalities for automating real time collection of information from the end user concerning, for example, compliance with the schedule and/or protocol. The collected data can be remotely accessed, in real time, to monitor compliance/adherence and an end user's experiences resulting from compliance/adherence. Further, the management messages are so designed as to be highly personalized in order to achieve a more favorable response from the end user.

### CROSS REFERENCE TO RELATED APPLICATION

This application claims the priority benefit of U.S. Provisional Patent Application No. 60/671,283, filed Apr. 14, 2005.

### FIELD OF THE INVENTION

The present invention relates generally to compliance/adherence with a schedule of events and, more particularly, to primarily using wireless communications modalities such as a cell phone, and in the alternative using non-wireless communications modalities such as IVR, for persistently and redundantly transmitting management messages to an end user for managing end user compliance with a schedule of events, and for collecting information, in real time, from the end user, such as concerning completion of the events in the schedule and/or pertinent data such as personal medical metrics and other related data, processing the data and sending, in real time, intelligent management data back to the end user. Further, the management messages are so designed as to be highly personalized in order to achieve a more favorable response from the end user.

### BACKGROUND OF THE INVENTION

It is well known that individuals do not always closely follow schedule and/or disease management protocols that require certain actions to be performed at specific times because of, for example, distractions, forgetfulness and the complexity of the schedule and/or disease management protocols and the components thereof.

In the healthcare field, the problem of an end user, such as a patient or clinical subject, failing to comply with a medication and/or treatment protocol has existed for many years. It is estimated that approximately, at a minimum, 40% of patients fail to take their medications or use their medical devices as required by time driven protocols. The failure to follow protocol requirements, commonly known as non-compliance and/or adherence, can result from an inadvertent violation of a treatment schedule; intermittent treatment compliance; deliberate skipping of treatment; confusion caused by the prescription of multiple medications and complex treatment schedules; medication dosage conflicts that result when medications, foods, vitamins, etc., that can interfere with one another are prescribed together; and human forgetfulness. Human forgetfulness is the most common reason for non-compliance, and usually results from poor discipline, human denial or cognition problems.

Non-compliance/adherence has been identified as the single greatest source of medical treatment failure and adverse effect outcomes on patients. Over the last ten years the problem of patient non-compliance/adherence has increased because of the introduction of more powerful and response specific drugs and medical devices, which require more rigid compliance habits for both effectiveness and safety. The consequences of increased non-compliance/adherence include loss of faith and trust in treatment protocols by patients, a negative impact on the prescribing habits of physicians and significant adverse effect outcomes on patients. Further, each of these consequences has contributed to significant market losses for a provider of a given medication, medical device and/or medical treatment.

Similarly, it has been found that each year substantial financial and human resources are wasted because patients fail to show up for scheduled medical appointments/treatments. As an appointment is often scheduled weeks or months ahead of time, it is common for patients to forget, or alternatively want to forget, a scheduled medical appointment/treatment.

It has been demonstrated that third party management and reminder mechanisms can improve patient compliance/adherence with medical treatment protocols and the likelihood that a patient will continue to obtain medical services, which can be preventive or part of an ongoing medical treatment program. If patient compliance/adherence is properly managed such that patients are reminded redundantly and persistently to complete an event of a schedule, and if a patient is also educated as to why compliance is important, and disease management protocols are followed as required, the overall effectiveness of healthcare services can be increased and healthcare costs can be reduced.

Furthermore, at the present time many new drugs, medical devices and medical treatments are under development. It is in the public interest that government approval for same be obtained as quickly as possible. Significant amounts of precise, regulatory compliant clinical data, however, need to be collected from end user subjects that participate in clinical drug, medical device and medical treatment trials to satisfy government regulatory requirements. Currently, the approval process proceeds relatively slowly because data collection from clinical trial subjects involves complex, highly structured protocols that are easily corrupted and do not involve much automation. Prior art automated data collection systems, some of which utilize web-based tools, do not have the capability to collect from the end users the precise, conclusive and unbiased clinical data required to achieve successful clinical trial outcomes. In addition, similar to the situation of a non-compliant patient that is not a participant in a clinical trial, it is typical that a significant population of a clinical trial subject group forgets or chooses not to comply with the clinical data collection protocol requirements. Such non-compliance slows and increases the cost of the approval process and, therefore, increases the time it takes for a new drug, medical device or medical treatment to become available to the public.

Therefore, a need exists for a cost effective and simple to use system and method for managing compliance/adherence of an end user with a schedule of events, such as a healthcare treatment protocol, by persistently and redundantly transmitting maintenance messages to the end user concerning the scheduled events; for automating real time collection of information from the end user, such as relating to compliance/adherence with the required schedule; processing the data and sending, in real time, intelligent management data back to the end user; and for making the collected information available for review from a remote location in real time.

### SUMMARY OF THE INVENTION

In accordance with the present invention, an interactive compliance/adherence and automated data collection system utilizes a plurality of communications modalities, such as text, graphic, voice or email messaging over preferably a wireless communications system and alternatively a wired communications system, for transmitting management messages persistently and redundantly to an end user for managing compliance/adherence of the end user with a schedule having time dependent events and/or pertinent data such as personal medical metrics and other related data, processing the data and sending, in real time, intelligent management data back to the end user. The system also utilizes the communications modalities for collecting data, automatically and in real time, from the end user concerning, for example, compliance with the schedule. The communications modalities used for messaging are selected specifically for the requirements of the end user, and the end user has at least one communications device, such as a cell phone, cell phone equipped PDA, smart phone, etc., with which the system can communicatively interact.

The communications interactions include transmission of a personalized message to the end user's communications device(s) to manage compliance with the schedule, and, if suitable, reception of a responsive or end user-initiated message confirming compliance with the schedule and optionally including other related information, such as a description of the end user's experiences resulting from compliance with the schedule and/or pertinent data such as personal medical metrics and other related data, processing the data and sending, in real time, intelligent management data back to the end user. The collected data is stored on the system and an authorized individual, by providing an access code such as a password, can remotely access the data in real time via wireless or wired communications systems.

In accordance with a preferred embodiment of the present invention, an interactive healthcare compliance/adherence and automated healthcare data collection system utilizes communications modalities implemented over a wireless communications system, and in the alternative a wired communications system, for transmitting management messages persistently and redundantly to an end user, such as a patient or clinical subject, for managing medication, and medical device and/or medical treatment compliance/adherence of the end user. The system also utilizes the communications modalities to automate collection from the end user of compliance/adherence data and other information relating to compliance/adherence, such as clinical data needed to obtain regulatory approval for new medications, medical devices and/or medical treatments. The system includes a server that, using one or more communications modalities, transmits personally specific management messages to communications devices of an end user for managing a compliance/adherence schedule. The server also automatically collects data concerning compliance/adherence based on the absence of a response to a management message, or the receipt of a response message that the end user transmits to the server from his communications device. The system is preferably web enabled to permit authorized persons, such as providers of medication, medical devices and/or medical treatments, and also managers who monitor patient compliance/adherence with a schedule, to remotely access, in real time, the collected data over wireless or wired communications systems by entering an access code, such as a password.

In a preferred embodiment, the system communicatively interacts with wireless communications devices of an end user for managing compliance/adherence and automatically collecting compliance/adherence and associated data using wireless communications protocols, such as a short message service (“SMS”), a multimedia messaging service (“MMS”), video streaming, IVR, and/or a wireless based internet connection that provide for instantaneous two way messaging transmission. In still a further preferred embodiment, the communications interactions are between an end user patient and a provider of medication and/or medical devices, or a medical treatment compliance manager.

In a preferred embodiment of the invention the management messages are so designed as to be highly personalized in order to achieve a more favorable response from the end user.

### BRIEF DESCRIPTION OF THE DRAWINGS

Other objects and advantages of the present invention will be apparent from the following detailed description of the presently preferred embodiments, which description should be considered in conjunction with the accompanying drawings in which like references indicate similar elements and in which:

FIG. 1 is a block diagram of an exemplary interactive compliance and automated data collection system in accordance with the present invention.

FIGS. 2A, 2B, 2C, 2D, 2E and 2F illustrate exemplary screen displays generated at a wireless communications device of an end user of the system of FIG. 1 in accordance with the present invention.

FIG. 3 is an exemplary preferred embodiment of an implementation of the system of FIG. 1.

FIG. 4 is another exemplary preferred embodiment of the system of FIG. 1.

FIG. 5 is another exemplary preferred embodiment of the system of FIG. 1 illustrating communications modalities in accordance with the present invention.

FIG. 6 is a flow diagram of an exemplary process for defining a schedule for transmitting management messages in accordance with the present invention.

### DETAILED DESCRIPTION OF THE INVENTION

For purposes of highlighting the features of the present invention, a method of and a system for interactively managing compliance/adherence, and for automatically collecting compliance/adherence and associated data in real time, using communications modalities implemented over primarily a wireless communications system, and alternatively a wired communications systems, are described in detail below in connection with the management of schedules arising in the healthcare field. It is to be understood that the method and system of the present invention are readily applicable to other fields, industries and interests, such as machine maintenance, weight reduction, personal training and habit reinforcement, that require management of compliance with a schedule and also require automation of real time collection of data concerning compliance with the schedule.

In the healthcare field, physicians, nurses, para-professionals or designated caretakers, who can be a family member or friend of a patient, manage a patient's compliance/adherence with a healthcare schedule, which can include taking medication, using certain medical devices and/or implementing a medical treatment at scheduled times. This includes collecting data and sending it back to the provider or an automatic system managed by the provider which in turn processes the data, in real time, and sends intelligent management data back to the end user. In addition, pharmaceutical and medical device manufacturers, medical treatment providers, and those who manage or enable distribution of various medical products and/or services, often need to obtain clinical data from end user subjects or patients who participate in clinical trials. The inventive method and system facilitate interaction with the end user preferably in real time, and using communications modalities implemented over preferably wireless communications systems, and alternatively wired communications systems, for managing compliance with a healthcare schedule. In addition, the inventive method and system automate collection of compliance and associated data from the end user, such that the collected data can be accessed remotely and in real time by a compliance manager and/or a provider of healthcare products and/or services.

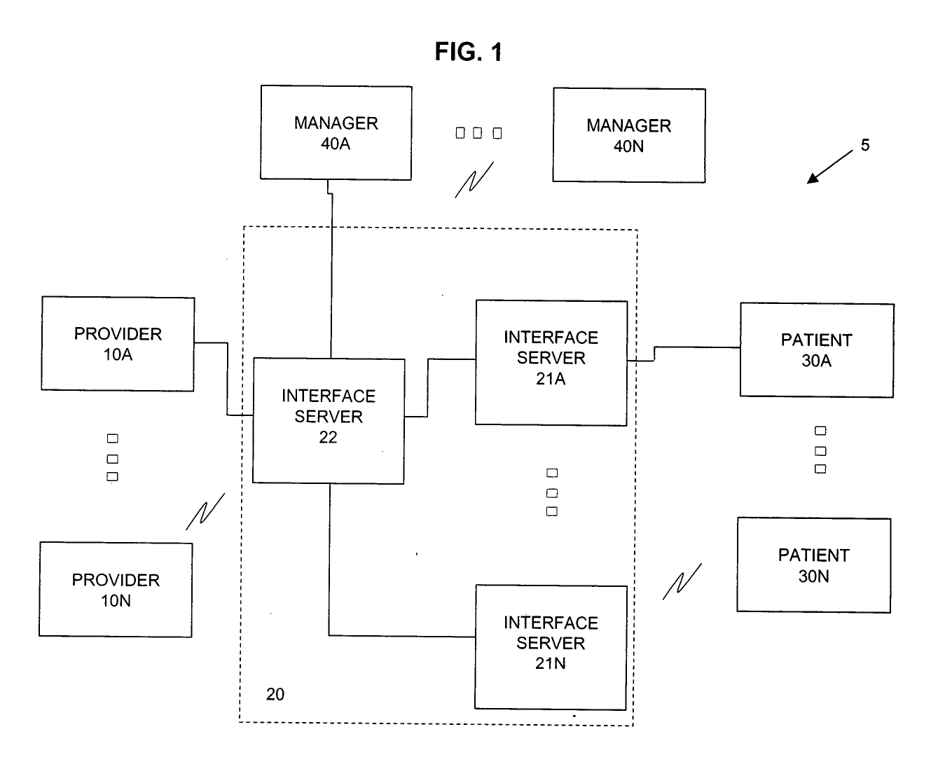

FIG. 1 is a block diagram of a preferred interactive compliance management and automated data collection system 5, in accordance with the present invention, that uses a plurality of communications modalities, preferably implemented over a wireless communications system, for managing, preferably in real time or substantially real time, compliance of an end user patient 30A . . . 30N with a healthcare schedule and for automating real time collection of information from the patient concerning, for example, compliance/adherence and the effects of compliance/adherence on the patient. Referring to FIG. 1, the system 5 includes a server 20 which is accessible over a communications network, such as the Internet, world wide web or like network, and to which communications links with a plurality of communications devices can be established using an existing communications infrastructure, which can include wireless and wired communications systems. As discussed in detail below, the communications links are utilized to transmit management messages to, and receive confirmation or responsive information messages from, end users who are required to follow a healthcare schedule, such as a medical treatment protocol or a clinical drug trial protocol having preset time and event requirements for performing said events on the schedule. The server 20 includes an interface server 22 that can be communicatively coupled to a communications device of any one of a plurality of providers 10A . . . 10N, such as pharmaceutical, medical device and/or medical treatment service companies or ancillary providers such as a food supplement service company that may provide medication to an end user patient 30 . . . 30N as part of a clinical trial or a conventional medical treatment program. In addition, the interface server 22 can be communicatively coupled to a communications device of any one of a plurality of managers 40A . . . 40N, such as medical professionals and para-professionals or friends or family members of a patient that manage compliance of the patient with a healthcare schedule.

The server 20 further includes a plurality of user interface servers 21A . . . 21N coupled to the server 22. The user servers 21A . . . 21N can be communicatively coupled to one or more communications devices of each of the plurality of end users 30A . . . 30N who are registered with the server 20 as part of a messaging subscription, as described in detail below. The end user 30 may be a conventional patient who is being managed by a physician manager 40A . . . 40N and/or surrogate, or alternatively a participant in a clinical trial being conducted by a pharmaceutical company provider 10A . . . 10N or equivalent.

It is to be understood that the server 20 containing the user interface servers 21 and interface servers 22, which is described below as performing data processing operations, is a software module or, alternatively, a hardware module or a combined hardware/software module having wireless and wired media communications capabilities. In addition, the server 20 suitably contains a memory storage area, such as RAM, for storage of data and instructions for performing processing operations in accordance with the present invention. Alternatively, instructions for performing processing operations can be stored in hardware in the server 20.

The interface server 22 preferably is a conventional application programming interface (“API”) that provides for integration of interactive communications applications, which are defined by messaging subscriptions established at the server 20, with external data processing applications having, for example, real time data lookup and data transfer functionalities. In a preferred embodiment, the interface server 22 can establish communication links with the manager or the provider using HTTPS or SOAP/API communications protocols, as well known in the art.

The user interface servers preferably are accessible via any common web browser and can be embedded into any web site using HTTPS.

Each manager 40 and provider 10 has at least one communications device, such as a conventional personal computer that includes wireless or wired communications capabilities, whose electronic communications address is registered with the server 20. Each end user 30 has at least one communications device, such as a cell phone, cell phone equipped PDA, smart phone telephone or personal computer having a DSL or cable modem communications capability, whose electronic communications address is registered with the server 20. Thus, each end user 30 can be communicatively linked to the user server, or to the manager or the provider via the servers 21 and 22.

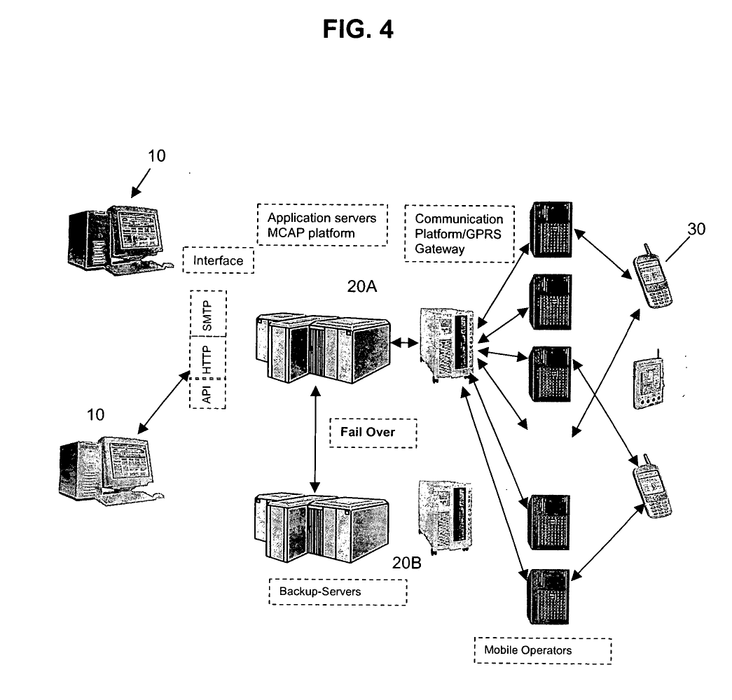

In a preferred embodiment, the system 5 includes a primary server 20A and a back-up server 20B, as shown in FIG. 4, to provide complete redundancy for all data storage.

In a preferred operation of the system 5, the server 20 communicatively interacts with each of the patients 30 to manage compliance/healthcare with healthcare schedules and also automatically collect compliance data and also clinical data, as suitable. In accordance with a messaging subscription that is defined at the server 20 and sets forth a messaging schedule for a specific end user patient 30, the user interface server 21 generates a personalized user interface or display containing a personalized management message at a selected wireless communications device of the end user patient 30, such as a cellular phone or PDA. The patient 30, along with his manager 40 or the provider 10, can select from a variety of communications modalities for use in transmitting a management message that generates the user interface at the communications device of the patient 30. In addition to one-way messaging, where only management messages are transmitted to the end user, the system 5 also provides for two way messaging, where the server 20 transmits messages to and receives responsive messages from the end user 30. Then in turn, if applicable, processes the received message (data) utilizing medical metrics and medication and/or medical treatment management protocols and sends back to the end user medical treatment recommendations. The application server 20 automatically times and time stamps each message transmission and receipt of a responsive message for each end user, and stores data representative of such information and the contents of responsive messages in its memory.

Consequently, historical data for an end user or a group of end users can be retrieved to generate reports validating that a management message has been transmitted and tracking compliance and clinical progress, as suitable. For example, management messages are stored and identified in the server using a submission timestamp actual state, such as transmitted or received; a reception timestamp; and source and destination information. Further, messages involved in two way communications are identified in the memory of the server 20 as being in the “inbox,” “outbox” or “delayed”, as suitable.

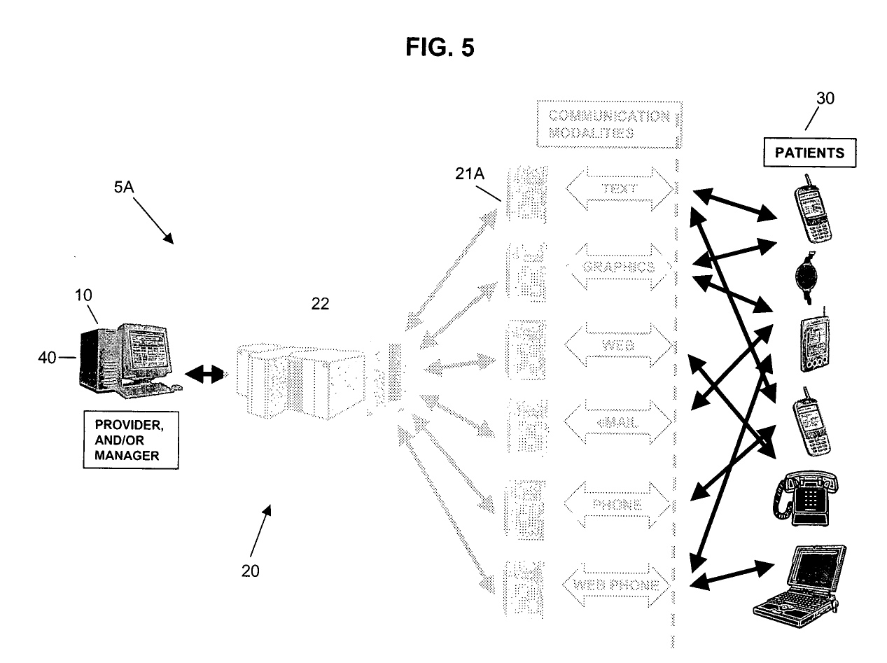

In a preferred embodiment of a system 5A as shown in FIG. 5, the user interface server 21 establishes communications links with patients 30 using such communications modalities as wireless access protocol (“WAP”); WAP push protocol, which under certain conditions can provide limited graphics and sound; wireless text messaging, such as a short message service (“SMS”) or multimedia message service (“MMS”), the latter of which is capable of sound, graphics including pictures and animation; email; cHTML; xHTML; XML; and voice messaging via land line phone or web phone (VOIP), as well known in the art. In a most preferred embodiment, the user server 21 transmits messages compatible with communications technologies that guarantee outstanding quality with extremely low delay and delivery confirmation.

The inventive system preferably uses conventional digital encryption and security technology to secure the data being communicated and the data stored at the server 10. In a preferred embodiment, the inventive system uses conventional encryption and secure access techniques to ensure that end user identification data, such as the name, phone number and e-mail address of an end user, are only used during the short period associated with an interaction between the end user 30 and the server 20.

In accordance with the present invention, the user interface generated at the user's communications device is unique to the user and the compliance management function being performed, such as a reminder to take medication. The content and style of the management message displayed as the user interface on the user's communications device, or other messages transmitted to the patient for collecting data, can be simple or highly personalized and are selected by the patient, provider or manager, or a combination thereof, to maximize the likelihood that the patient will comply with the medical treatment schedule requirements.

In a preferred embodiment, the management message includes psychological reinforcement content that is likely to generate a positive reinforcement impact or negative reinforcement impact on the end user, so as to appeal to and/or motivate the user psychologically to cause the end user to take the necessary action to comply with the schedule of events. The nature and style of the reinforcement content are designed, for example, in view of classical mental responses, such as the family obligation response of the primary provider who needs to remain healthy for his family and the personal relationship response of the grandparent to a grandchild's picture or voice that urges the grandparent to take medication.

In a further preferred embodiment, the user interface is customized to integrate in a transparent manner with a website of an Internet site, and include selected styles and characteristics, as desired.

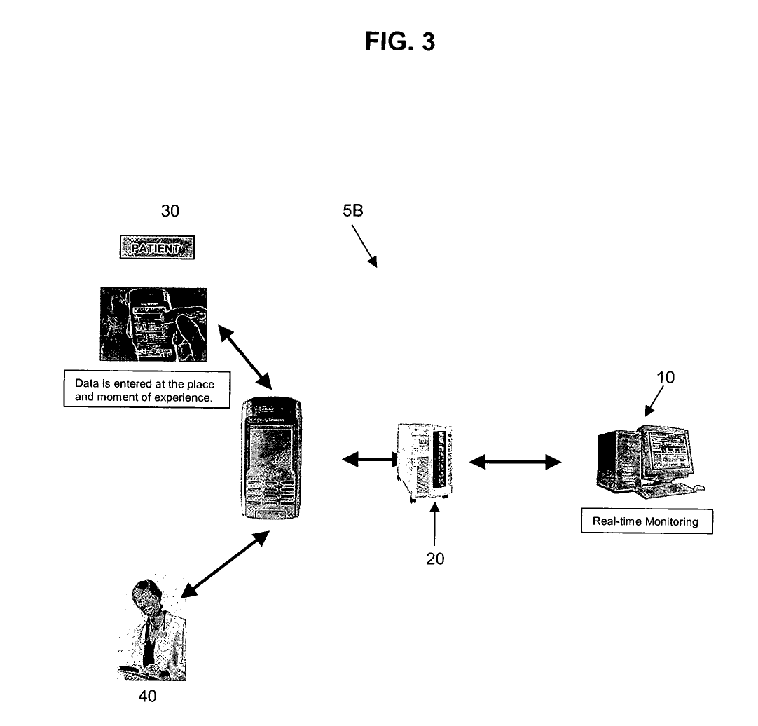

Referring to FIG. 3, in an exemplary preferred embodiment of a system 5B, automated collection of data in real time is performed, for example, using wireless phones that use WAP 2.0 or cHTML browsers. An end user patient 30 accesses questionnaires via a secure connection to the server 20 using WAP or HTML browsers or, for example, a SMS communications modality over a digital wireless network. The server 20 stores responses transmitted by the end user in a diary account established for the end user. The manager 4 can then access the end user's data at the server 20 using the same type of wireless phone and communications modality that the end user uses to transmit data to the server 20. Thus, the system 5B provides for interaction with the patient 30 so that the patient can complete the questionnaire, and also for interaction with the manager 40 so that the manager can, for example, complete an electronic clinical report form (e-CRF) as part of a clinical reporting process for both the purposes of managing the end user and/or research and development purposes.

In a preferred embodiment, the provider 10 or manager 40 can establish a management messaging subscription with the server 20 over the Internet using an online interactive protocol, or alternatively by using an offline subscription registration procedure. In addition, a patient 30 can transmit simple SMS string messages to the interface server 21 to establish a messaging subscription with the server 20.

The management messaging subscription defines one or more management messaging applications that the server 20 performs to manage compliance/adherence and automatically collect compliance/adherence data from the end user. In particular, the subscription sets forth the timing, content and characteristics of messages to be transmitted to an end user to ensure that the end user complies with a healthcare treatment schedule and protocol, and that data is automatically collected from the end user concerning compliance with the schedule and protocol. Further, the subscription defines the communications modality, the user interface and the address of destination communications devices for each management message to be transmitted. In addition, a different user interface can be defined for each management message to be transmitted, where each management message can have a different content. The content of a management message may be entirely defined, partly defined or entirely generated when the subscription is initiated. The subscription also defines access rights to the end user data, and the types of statistics and reports that will be generated from the collected data. Table 1 shows an exemplary schedule for transmitting reminder messages having varying content in accordance with delivery times that the server 20 can perform when executing a messaging application defined in a messaging subscription at the server 20.

TABLE 1

| Management Message | Delivery time | Message Content |
|---|---|---|
| Welcoming Message | Date of | Thanks for registering |
| | registration = Day 1 | with the asthma check |
| | | up service |
| 1^{st} reminder | Day1 + 7 | Hello, feeling any |
| | | better with your |
| | | asthma treatment? |
| | | Don't forget to take |
| | | your inhalations |
| | | regularly |
| 2^{nd} reminder | Day 1 + 14 | How have you been |
| | | doing with your |
| | | asthma this week? |
| | | Do not forget to take |
| | | your inhalations |
| | | because it will |
| | | directly affect |
| | | your health status! |
| 3^{rd} reminder | Day1 + 21 | |
| . . . | | |
| 52^{nd} reminder | Day1 + 364 | |

The message content and style are preferably selected to satisfy personal desires and characteristics of an end user, which increases the opportunity for a successful response to a compliance reminder.

In another preferred embodiment, the subscription is defined so that the server 20 transmits management messages by SMS, e-mail, SMS and e-mail, in sequence, and that the end user must transmit an acknowledgment to the server 20 that the management message was received. The requirement of an acknowledgment confirms that a communications link was established with an indicated destination address of an end user and ensures that the destination address is valid.

Further, the subscription can provide for simple, complex or recurring management messaging schedules that define the date and time at which management messages are transmitted. For example, the following five distinct categories can be used to define management message delivery times and dates. An immediate management message is transmitted at the time of registration. A delayed management message is delivered at a deferred date, based on a selected date in a calendar option. A scheduled management message is a suite of management messages each of which is transmitted at different specific dates. For example, the transmission of a management message to take asthma medication can be scheduled to occur daily for one year. A conditional management message is transmitted depending on a follow-up action, such as when a condition is met. For example, a reward management message is transmitted if a “yes” response is received following a reminder to take medication. A database triggered management message is transmitted to specific end users identified in the server 20 as requesting information concerning a certain topic about which information recently was received at the server. For example, if information identified as news concerning a specific topic is provided to the server 20, the server 20 attempts to match any users subscribing to that topic and then transmits the news to the matches.

In a preferred embodiment, management messages are transmitted to an end user according to a subscription that includes redundancy and persistence features. The redundancy feature provides that a management message concerning the same event of a schedule is transmitted using a plurality of the communications modalities. The persistence feature provides that the management message transmissions continue to be transmitted for each of the respective modalities at predetermined intervals until the system receives a responsive message from the end user.

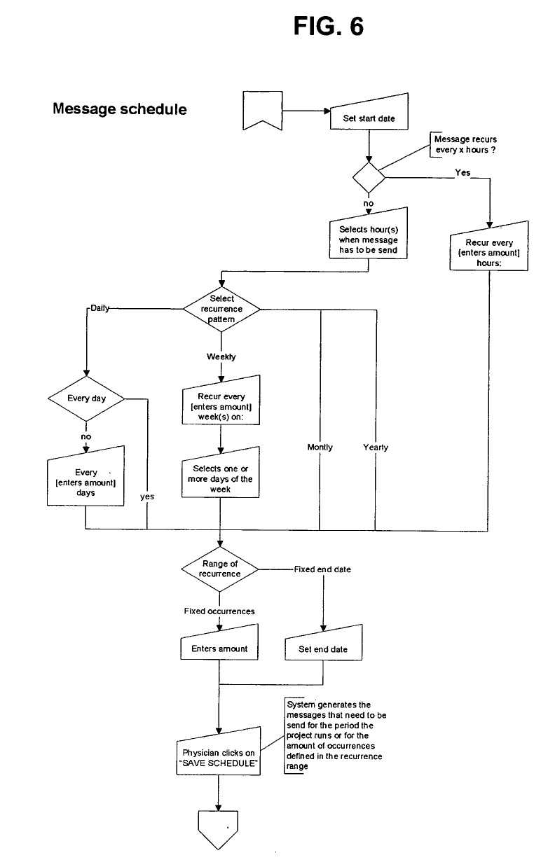

In a preferred embodiment, the manager 40 can perform steps of an exemplary process as shown in FIG. 6 to define, in the server 20, an application setting forth a schedule for transmitting medical treatment management messages. For example, the management message application can be defined using the following parameters: starting date(s); message by week, day or hour; treatment length or period; treatment frequency; and message frequency.

In a preferred embodiment, the server 20 transmits simple SMS text messages to a wireless communications device of a patient 30 to collect real time data representative of any adverse events associated with a patient's experience in complying with a medication schedule. In a further preferred embodiment, the SMS messages include graphics and sound. In an alternative preferred embodiment, the server 20 transmits messages using MMS or like services, which similarly provide that a management message can include multi-media enhancements such as sound, images and other rich content. The transmission of a personalized visual and audio management message to, for example, patients suffering from language, cognitive, sight or hearing problems, increases the likelihood of compliance/adherence and also the collection of clinical data.

The server 20 also preferably supports transmission of a MMS message from a phone of the patient 30 to the phone-to-email account of a manager 20, or vice versa. Also the phone can encompass IVR capabilities.

In a preferred embodiment, a medication and/or treatment provider defines a treatment management messaging application in the server 20 that is country specific, consumer target specific and therapeutic area specific. For example, the server 20 performs a treatment management messaging application wherein the server 20 transmits, to clinical patients of a provider who reside in a particular geographic location, pre-defined SMS messages about a specific treatment, such as asthma inhalations, according to a preset schedule that conforms to the protocols of the geographic location.

In a preferred embodiment, the server 20 performs a management messaging application that requires the server 20 to await a message notification from an end user 30 confirming that a specific medication was taken at a prescribed time. If the server 20 does not receive such notification within a predetermined time following the prescribed time, the server 21 repeatedly transmits a management message to the end user, at predetermined intervals, until the end user transmits a responsive message that the medication has been taken. In this manner, the end user can transmit a single message to acknowledge that the medication has been taken according to the healthcare protocol, thereby simplifying the management and message notification processing and avoiding the need for the server 20 to transmit a single message or multiple management messages to the end user.

In a preferred embodiment, the server 20 includes conventional language translation capabilities and operates to translate contents to be included in a management message from a first language, such as English, which a manager uses to define a subscription, to a second language, such as Mandarin, which the end user understands and needs to use to respond to a management message. In this embodiment, the management message is displayed to the end user in his native language and the end user can respond to the message in his native language. The server 20 translates the response into the native language of the manager, such as English, and stores the contents of the response in memory in both English and Mandarin. Consequently, both the English speaking manager and the Mandarin speaking patient can have access to the same collected data.

In a further preferred embodiment, the server 20 maintains subscription contracts and ensures that necessary fees are paid to continue the subscription. For example, the server 20 monitors management messaging in terms of specific message units, defines currency credits in relation to message units and notifies the subscriber about credit expiration.

In a further preferred embodiment, the server 20 assesses a fee to the account of an end user for an initial notification and for each additional repeated management message. The assessment of fees based on the number messages transmitted creates a financial incentive for compliance/adherence.

In a further embodiment, a monthly fee is assessed to the account of an end user if a premium reminder service, such as daily transmission of a management message including the current pollen count, is utilized.

In another preferred embodiment, the server 20 implements a subscription for an end user who must follow a medication protocol where the subscription requires redundant and persistent message transmission using a predetermined sequence of communications modalities and that the reminder messages are highly personalized. The communications modalities can include, for example, wireless messaging to a cellular telephone or cell phone equipped PDA, voice messaging, smart phone, email and the like. The sequence of the communications modalities, and the message contents and characteristics utilized for each of the modalities in the sequence, are selected in advance by the manager or provider to obtain the highest likelihood of compliance by the end user. Compliance, in this embodiment, requires a response from the end user.

For example, the user server 21 initially transmits an SMS text message to the cellular phone number of an end user 30A, and if no response is received within a predefined response time, transmits a voice message to a land line telephone number of the end user 30A and preferably again transmits a message to the cell phone number if no response is received within a predetermined time from such transmission(s), the user server 21 transmits an email to the email address of the end user 30A via an internet web service and again transmits messages to the cell phone and via voice mail. The sequence of message transmissions using different communications modalities, the repetition of message transmission for the respective communications modalities and the use of different message content characteristics for the respective communications modalities, continues until the server 20 receives a response from any communications device of the end user.

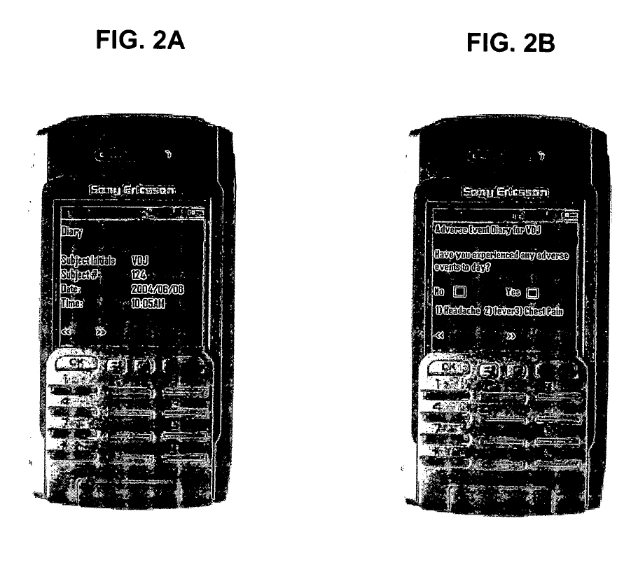

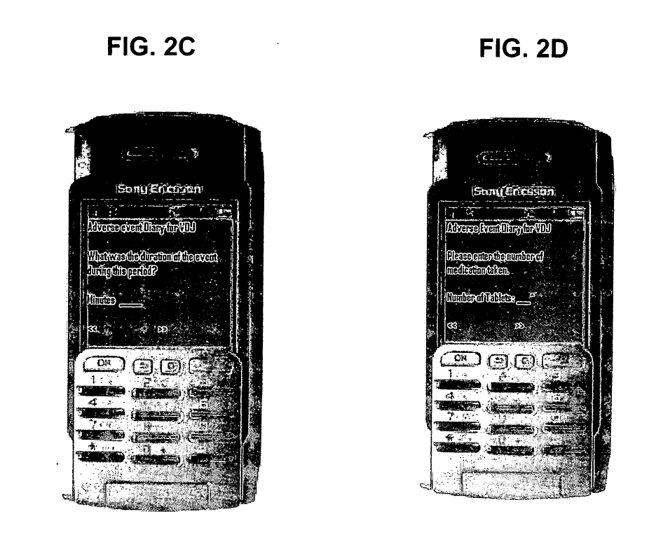

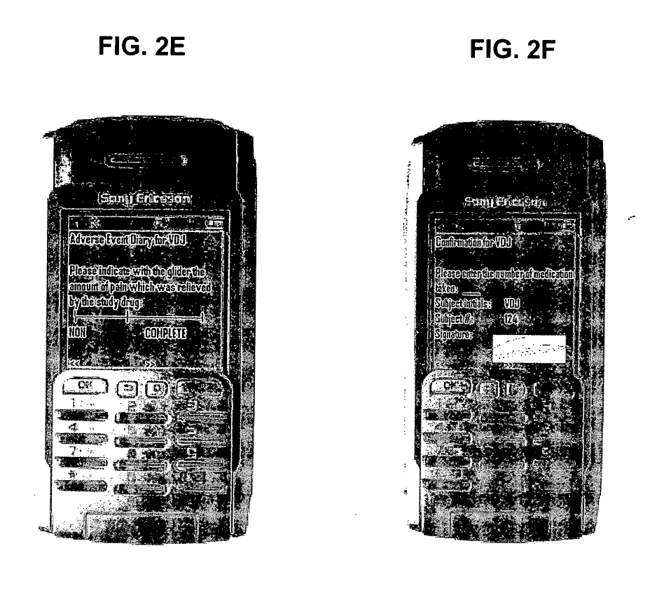

FIGS. 2A-2F show exemplary user interfaces that the user server 21 can generate on a display of a wireless communications device of an end user patient 30, such as a wireless phone or cell phone equipped PDA, in accordance with the present invention to collect compliance and/or research data and/or outcome data from the patient. The font, point size and data collection elements on the interface are predetermined and specific to the patient. For example, the text size can be enlarged and represented in the form of icons if a patient has poor eyesight or impaired motor skills. In addition, the content and the set-up of various parameters for the interfaces can be modified as to language and coloration. Further, the content can be modified to include, for example, a responsibility disclaimer or to suppress, for example, specific options and menus provided to other end users. The user server 21 time stamps all responsive entries made by the end user so that the time when the end user answers a question is always known and available for retrieval.

Referring to FIG. 2A, as part of an application for collecting data, the user interface server 21 causes the communications device of the end user patient to display an initial diary screen containing the end user's personal information. When the patient receives such communications, the end user enters login data, such as a unique access code that prevents anyone other than the end user to input data or access data stored in the server 20, and then transmits the login data back to the server 21. Similarly, managers or providers can access the data in the server 20 as it is collected or after collection for each end user patient of a group of patients only by first entering an access code.

Upon verification of the access code at the server 20, the end user can then transmit further information to the server 21, such as confirmation of receipt of reminder inquiry concerning compliance/adherence. For example, the server 21, based on the healthcare schedule for the end user, transmits an SMS message that prompts the user to complete his diary according to the required protocol.

In addition, the server 20 uses transaction timeouts to cancel an interaction with an end user after a pre-determined amount of time has passed following a transmission from the server 20 and the server 20 has not received a response from the end user.

Referring to FIGS. 2B, 2C and 2D, exemplary event assessment screens are displayed on the wireless device of the end user patient as part of the application for collecting compliance/adherence data. The screens request the patient to answer questions regarding drug or treatment experience, such as the duration of the event, the amount of medication taken, and/or outcomes. Referring to FIG. 2B, after the user inputs his access code, the server 21 transmits an inquiry message that presents the user with an initial event assessment question. The user selects the appropriate answer, e.g., yes or no, and then can move on to the next screen by touching a key on the device corresponding to a forward arrow. By touching the key, the response is transmitted to the server 20, which in turn causes the server 20 to transmit another inquiry message to the end user 30.

Referring to FIG. 2C, the server 21 transmits an inquiry message that requires the user to enter data and the user cannot move forward through this screen until after the data, such as, for example, the number of minutes the event lasted, is entered. In a preferred embodiment, the schedule for the end user defines what specific answers are required and what questions can be skipped over without requiring answers.

Referring to FIG. 2D, the server 21 transmits an inquiry message that requires the user to enter the number of minutes of an event episode by, for example, depressing number buttons or a touch pad sensitive number spinner, or by using an input device such as a stylus on a touch screen, of the wireless device. For example, the user enters the number of medication tablets taken. If the number is zero, the server 21 automatically skips a subsequent question, which may concern the amount of relief the medication provided. After the user enters the number of minutes, the forward arrow appears so as to allow the user to transmit the information back to the server 20 and the server 20 proceeds with automated data collection.

In a preferred embodiment, the server 20 checks the information received from the end user to ensure that accurate data has been entered. For example, the server 21 transmits an error message and requests the user to re-enter data if the initial entry for the screen of FIG. 2D exceeds a known upper limit of a tablet dosage for the medication schedule of the end user.

Referring to FIG. 2E, the server 20 transmits an inquiry message that causes display of an electronic visual scale (“EVS”). The EVS includes a cursor that eases the ability of the patient to input outcome information, such as amount of pain. Thus, the EVS advantageously allows the user to assess and visually represent the amount of relief provided by the medications. The electronic input of the pain results provides that representative scores of pain relief can be automatically calculated without the end user's physically measuring markings on paper diaries, as sometimes is performed in the prior art to represent relative pain relief. In addition, a manager 40 or provider 10 can readily remotely access the computed score from the server 20.

Referring to FIG. 2F, the server 21 transmits an inquiry message that causes display of a confirmation and signature screen display. The display includes an electronic signature portion that is used to authenticate that the data entries are being made by an authorized end user. A user cannot complete a series of entries, such as required by the exemplary screen displays shown in FIGS. 2B, 2C, 2D, 2E and 2F, without providing a digital signature at the final display screen in the series. The patients easily enter their digital signature by writing their pin code using conventional figures (0 to 9) with a stylus on the touch sensitive screen or using the keyboard of their cell phone equipped PDA. The digital signature text box is presented with the appropriate text to ensure that the patient understands that by signing, he is taking responsibility for all the truthfulness and validity of all data submitted. The digital signature and associated timestamp information are preferably included in every report generated using information entered by the end user patient.

In an alternative preferred embodiment, the interface server causes the communications device of the manager to display an initial electronic report form. The server provides that the manager can complete the form and the data is transmitted to the server in a manner similar to that described above concerning interaction between the server and the end user for collecting data from the end user.

In a preferred embodiment, the server 20 transmits a management message to the end user that includes an image or video that is displayed on the end user's cell phone equipped PDA and/or smart phone and demonstrates how medication should be taken, such as under the tongue.

In a preferred embodiment, the manager defines, for a particular user or group of users, the addresses of communications devices to which management messages will be transmitted, the sequence in which the transmissions to the devices occur and when the transmissions occur. For example, the manager defines a schedule that causes transmission of a “pollen alert” message to a communications device destination of a single end user or to multiple, distinct communications device destinations corresponding to respective end users of a group of end users. The message is transmitted to the appropriate end users as soon as the amount of pollen in the air reaches a predetermined level. The pollen level information is preferably automatically transmitted to the server 20 from a manager's communications device in the form of a message containing the current pollen count and where the pollen count information is in a format that can be readily extracted from the message by the server 20.

Alternatively, an end user can select, from a list of alert fields, the type of information he wishes to receive and such alert field information is stored in the server 20. The server 20 then transmits an alerting message to the end user as soon as a specific event is detected.

An end user alert application reinforces the prevention feature of a program that manages healthcare schedule compliance/adherence by alerting end users of specific information related to their medical treatment goal, such that additional measures can be taken before symptoms occur or become intense. For example, the server 20 transmits the pollen alert in real time to end users registered to receive such alert. The pollen alert is specific to registered end users according to their indicated geographic areas and the pollen level information received for the respective geographic areas. Based on the alert, the end users can then adjust their medication intake accordingly within medically permissible limits.

In another preferred embodiment, the server 20 performs an end user news alerting application where the server 20 transmits advice and health information messages to end users, and also invites end users to ask for more information. An end user can select from a list of types of news information to be transmitted, such as a tip of the day, weekly news, treatment or disease information, etc. The server 20 records the type of news message requested by the user and then automatically transmits a notification message to the user concerning the indicated news type when it becomes available.

In a preferred embodiment, the server 20 analyzes collected responses from an end user and, according to pre-determined criteria set forth in a messaging subscription for the end user set up by a provider, transmits an appropriate follow-up message to the end user. For example, if a provider seeks to promote loyalty of an end user 30A, the subscription for the end user 30A provides that the user 30A receives daily compliance/adherence reminders for his asthma treatment. After one month, the server 20 determines the number of “yes” responses that have been returned indicating end user compliance. If the end user has only returned nine “yes” answers, the server 20 then transmits “a need improvement” message to the end user. The following month the server 20 again checks the number of “yes” responses received from the end user. If the end user has returned 20 “yes” answers, the server 20 then transmits a positive reinforcement message such as “congratulations” message to the end user.

In a further preferred embodiment, the subscription provides for interactive communications with the end user using the SMS wireless communications modality before, during and following a compliance event, such as the end user's taking medication at a specified time. For example, the patient replies to a message containing a simple text question, such as whether the patient has taken his pill, simply by hitting the “reply” button on his communications device and typing a “Y” or “N” or a number, which causes the answer to be automatically transmitted to the application server 20.

In another preferred embodiment, the server 20 performs a doctor visit notification application where the server 20 transmits notification messages to end users that inform the end users that they have an office visit scheduled with their compliance manager. The transmission of office visit messages is determined by, for example, the scheduled office visit date and pre-set reminder date(s) and reminder time(s).

In another preferred embodiment, the server 20 performs a prescription refill management application that transmits messages to end users to inform them that they are due for a refill. The server 20 transmits refill reminders based on the refill date and preset reminder date(s) and reminder time(s). For example, a pharmacist manager can register an end user for treatment reminders as well as refill reminders. The server 20 communicates with an end user to determine if a refill has been obtained, and if not follow-up reminders are transmitted. The pharmacist manager can view and update refill status in the end user's schedule at the server 20, as suitable, depending on the end user's compliance actions.

In another preferred embodiment, the server 20 performs a loyalty management application to reinforce an end user's compliance with a schedule. The server 20 determines whether an end user is compliant or non-compliant with his schedule based on responses received from the end user, and accordingly transmits either reward messages or motivational messages to the end user. For example, the server 20 transmits reward messages to end users who are above a defined compliance limit, e.g., to end users who have at least a predetermined number of “yes” responses to compliance messages. The server 20 transmits motivational messages to end users below a defined compliance limit, e.g., to end users who have not responded to a predetermined number of compliance messages.

In another preferred embodiment, the server 20 performs an end user wireless buddy application where the server 20 transmits motivational messages, which can include multiple media features, to an end user. The motivational messages can be part of a medical treatment protocol that attempts to modify behavior of an end user who normally does not comply with medical treatment protocol requirements. For example, a family member that is manager of a patient, such as a grandchild for his grandmother, is likely to be very concerned with successful outcomes and can define a schedule so that the texts of the messages include the voice and the picture of the family member who supports the end user in achieving a healthcare goal, such as weight reduction. In an alternative embodiment, the motivational message includes a .wav file from and an image or video of a person who knows the patient, such as the grandchild of the patient, and where the .wav file has the grandchild saying, for example, “Grandma, it is time to take your yellow pill”.

In another preferred embodiment, the server 20 performs an end user feedback management application that expands data collection capability from the end user and analyzes collected data to enable treatment protocol improvements, course of treatment changes and adverse effect reporting. For example, the provider defines questions, such as concerning quality of life, symptoms, etc., and proposed answers that the server 20 transmits to end users for obtaining feedback. Types of feedback responses can be in the form of text or graphics; include a direct response, such as yes or no; track intensity, such as by indicating whether pain being experienced is low, medium or high; and describe a symptom, such as a headache, fever, etc.

In another preferred embodiment, the server 20 performs an end user emergency call application that provides the end user with the ability to record critical information in relation to a treatment schedule. The end user can initiate an interaction with the server to record, for example, the occurrence of an asthma attack in the end user's account, or to transmit a notification message to the manager requesting follow-up and including text such as “need a specialist” or “have doctor call me”.

In another preferred embodiment, the server 20 performs an end user appointment reminder application that informs the user of a scheduled appointment or the need to schedule a new appointment, and requires the user transmit a confirmation response message to acknowledge an existing appointment or accept or reject the suggested time for a new appointment.

In another preferred embodiment, the server 20 performs a medical management application that manages compliance/adherence of end users who have returned home following a stay in the hospital and have to take medication in accordance with a critical time schedule. The manager of the patient defines the medication schedule such that the server 20 transmits an SMS or MMS management message to the end user at a time when the end user needs to take medication. If the end user responds with a message that the medication has been taken, the hospital, in real time, can confirm whether the medication has been taken per the schedule from data stored in the server 20.

In a further embodiment, the manager can communicatively interact with the server 20 to transmit wireless messages to other managers registered with the server 20, such as certain doctors and nurses, to notify them of changes being made in the treatment schedule of an end user. In turn, the notified manager(s) can respond to the manager sending the management messages with any comments, as suitable.

In an alternative preferred embodiment, the end user can transmit wireless messages, such as wireless postcards or wireless get well cards, to individuals selected from a pre-defined list.

In an alternative preferred embodiment, the server 20 provides an end user with the ability to access information concerning a subscription that the end user, manager or provider established and to access data collected concerning compliance. Also, the managers or providers associated with a group of end users, according to access rights assigned to the managers or providers, can communicatively interact with server 20 to retrieve data concerning the details of the schedules and data collected for the individual end users of the group.

In a preferred embodiment, the server includes a control panel application that the end user or manager can access and which causes the communications device of the end user or manager to visually display, in a user friendly, easy to use format, all subscriptions existing for the end user and the current compliance status of schedules being managed for the respective subscriptions. The end user or manager can readily edit the parameters of any of the displayed subscriptions, such as the content of a message or the communications modalities to be used for message transmission, by manipulating keys or a stylus associated with the communications device.

In a preferred embodiment, the server 20 performs a clinical data collection application to collect data concerning patient experience with, for example, clinical trials, outcomes studies, compliance/adherence and marketing programs. The data collection process records precise, reliable and timely data for, for example, clinical study stakeholders and physicians over a secure validated network according to specified requirements. For example, physicians or study nurses can define an electronic clinical report form (“e-CRF”) that the server can wirelessly transmit to end users for completion. After the clinical data is collected, the server 20 makes the data available to the provider or manager for analysis in, for example, the standard CDISK XML protocol. The server 20 also provides that different types of statistics and reports can be generated in an extremely flexible and customizable manner using, for example, tables and graphs. In a preferred embodiment, the server 20 generates real time graphics analyzing identified types of collected data, such as user profiles, service interest, etc., and the retrieved data can be transferred for use by any conventional external software application, such as Excel, Access, CSV, PDF, etc.

In a preferred embodiment, the present invention provides for an integrated, real time data communications system that easily and effectively provides for the collection of patient data at the point of experience, from any location, with just a few touches of a button. The system uses an existing mobile phone line to transmit data directly from point to point, which makes communications secure and avoids the expense and complication of establishing a fixed Internet connection. The system can be personalized to provide an affordable and secure healthcare communications from any location for, for example, chronic-care patients whose vital signs need to be monitored regularly by their physicians. The system preferably provides for daily monitoring of such vital signs as blood pressure, heart rate, basal body temperature, body-fat content and weight, which are good indicators of the cyclical and non-cyclical changes that occur in the body and can be used to monitor the body's general health condition. The system can use the collected data for graphing the vital signs, which allows trends to become apparent and makes analysis faster and more accurate. For example, when a health condition exists, such as hypertension, asthma, diabetes, or heart failure, the system can be used to graph the vital signs with other factors, such as blood glucose and peak-flow meter readings, while comparing the data to answers to related questions, such as asthma.

Overall, the present invention uses wireless communications, and optionally wired communications, for persistently and redundantly transmitting management messages to an end user patient for achieving effective management of end user compliance, which in turn can improve treatment outcome and help motivate patients to continue compliance with healthcare schedules. The manager can educate and manage compliance of the end user at relatively low cost. The provider can collect research data and remotely review such data on a real time basis, as suitable, to learn potential adverse effects from treatments and also to provide further education to end users. The end user follows a managed protocol that does not require the end user to be self-dependent, which results in higher compliance with the treatment protocol and therefore improved health and a more successful and safer treatment outcome. An end user is more likely to comply with message notifications provided in accordance with the present invention because ergonomic, personalized interfaces that serve as reminders are generated at the end user's wireless communications device. The reminders advantageously provide positive and/or negative reinforcement, which encourages compliance.

Thus, the present invention provides method and system of compliance management that includes use of predetermined communications modalities, in a selected sequence and where the communications modalities are preferably wireless, to transmit reminder messages from a server to an end user, wherein the reminder messages are transmitted repeatedly for each of the modalities as the modalities are utilized and wherein the reminder messages continue to be transmitted until the server receives a responsive message from the end user.

Although preferred embodiments of the present invention have been described and illustrated, it will be apparent to those skilled in the art that various modifications may be made without departing from the principles of the invention.

We claim:

1. An interactive communications method, comprising the steps of:
a) transmitting a message to a user for managing compliance with a schedule;
b) receiving response data in real time from the user concerning schedule compliance;
c) storing the response data; and
d) remotely accessing the stored response data in real time.

2. The method of claim 1, wherein the transmitting step is performed over at least one of a wireless and a wired link.

3. The method of claim 2, wherein the transmitting step is performed redundantly over a plurality of the links.

4. The method of claim 2, wherein the transmitting step is performed persistently for a predetermined number of times.

5. The method of claim 1, wherein the transmitting step is performed by customizing the message to be unique for the user to motivate the user to comply with the schedule.

6. The method of claim 5, wherein the customized message contains multimedia.

7. The method of claim 1, wherein the transmitting step is performed by transmitting healthcare messages for managing compliance with a healthcare schedule.

8. The method of claim 7, and the step of processing the response data prior to storing it, and wherein the remotely accessing step is performed by authorized persons responsible for managing healthcare for the user.

9. The method of claim 8, and wherein the authorized persons transmit healthcare management data in real time to the user.

10. The method of claim 1, wherein the transmitting step is performed by transmitting the message to a handheld device supported by the user, the device having a display on which the message is viewable, and having data fields for user entry of the response data.

11. An interactive communications system, comprising:
a) a user interface server for transmitting a message to a user for managing compliance with a schedule, and for receiving response data in real time from the user concerning schedule compliance;
b) a main server for storing the response data; and
c) a manager interface server for remotely accessing the stored response data in real time.

12. The system of claim 11, wherein the user interface server is operative over at least one of a wireless link and a wired link.

13. The system of claim 12, wherein the user interface server redundantly transmits the message over a plurality of the links.

14. The system of claim 12, wherein the user interface server persistently transmits the message a predetermined number of times.

15. The system of claim 11, wherein the user interface server customizes the message to be unique for the user to motivate the user to comply with the schedule.

16. The system of claim 15, wherein the customized message contains multi-media.

17. The system of claim 11, wherein the message is a healthcare message for managing compliance with a healthcare schedule.

18. The system of claim 17, wherein the main server processes the response data prior to storing the data, and wherein the manager server only allows authorized persons to remotely access the processed response data.

19. The system of claim 18, and wherein the authorized persons transmit healthcare management data in real time to the user.

20. The system of claim 11, wherein the user interface server transmits the message to a handheld device supported by the user, the device having a display on which the message is viewable, and having data fields for user entry of the response data.
